(19) United States
(12) Patent Application Publication
(10) Pub. No.: US 2002/0138379 A1
(43) Pub. Date: Sep. 26, 2002

(54) Information lease management system, information lease management apparatus, information processing apparatus, information lease management method and recording medium

(76) Inventors: Miwako Yuasa, Kanagawa (JP); Kazuhiro Kita, Kanagawa (JP)

Correspondence Address: William S Frommer, Frommer Lawrence & Haug, 745 Fifth Avenue, New York, NY, 10151, US

(21) Appl. No.: 10/018,100

(22) PCT Filed: Mar. 29, 2001
(86) PCT No.: PCT/JP01/02676

(30) Foreign Application Priority Data
Apr. 12, 2000 (JP) 2000-111269

(51) Int. Cl. G06F 17/60

(52) U.S. Cl. 705/35

(57) ABSTRACT

In an information lease management system according to the present invention, in the case of managing lease of arbitrary information contents distributed from an information lease service provider to a user, an information lease management apparatus (1) and an information processing apparatus (3) are connected to each other by communication means (2). On one hand, utilization condition information concerning lease of information contents are added to the information contents by means of the information lease management apparatus (1), and then, is processed so as to be distributed to a user. On the other hand, information contents with utilization condition information distributed from the information lease management apparatus (1) are received, and are rented by means of the information processing apparatus (3). In addition, in the information processing apparatus (3), for example, when a lease period has expired, the rented information contents are managed so as to be automatically erased based on utilization condition information. There can be constructed a rental video system, a rental electronic library system, a home-use communication karaoke system using Internet or communication lines such as telephone lines or satellite communication lines.

### FIELD OF THE INVENTION

The present invention relates to an information lease management system, an information lease management apparatus, an information processing apparatus, an information lease management method and a recording medium that are preferably applied to a rental video system, a rental electronic library system and a home use communication karaoke system or the like using Internet or communication lines such as telephone lines or satellite communication lines.

### BACKGROUND ART

In recent years, in an information communication field, there has been many cases in which user-desired information contents are searched for using Internet or communication lines such as telephone lines or satellite communication lines, and the information contents suitable to user's purpose are acquired.

For example, free information contents such as shopping information or travel information are downloaded from a home page that an information provider opens to a user's information processing apparatus through a provider. In general, a utilization charge relevant to information contents providing service of such type is paid from the user to the provider, and a line use charge is paid from the user to the communication service provider.

In addition, in the case where an information provider provides buying type charged information contents, a trade charge relevant to charged information contents as well as the above described charges is paid from the user to the information provider. The user can use information contents acquired from the information provider freely.

In the meantime, in the case where an attempt is made to construct a rental video distribution service system (hereinafter, referred to as an information lease management system) for information contents such as leasing famous cinema video data, recorded video data, adult video data to an indefinite number of users, for example, by using a conventional communication infrastructure, the following problems occur.

<1> With respect to buying type charged information contents, such information contents are merely downloaded to a user, a charge corresponding to such download is collected, thereby ending a trade contract. However, if an existing download system is employed intact for rental video business without any change, thereby if information contents such as famous cinema video data are leased, the information contents are easily and illegally copied. Therefore, the rights of copy right owner may be illegally infringed.

<2> In addition, although a method of an adding illegal copy protect (command) to information contents is assumed, with a current personal computer, the information contents are freely operated by the user. Thus, the protection to prevent illegal copy may be easily unprotected.

<3> In a user's recording medium, a method of automatically erasing contents of lease information at a return limit is assumed. However, in this case as well, a calendar function is illegally operated by a personal computer, and the lease period may be illegally extended.

<4> Further, some of the rental video data must apply limitation to rental of the users that are less than 18 years old. There are various problems such as how to handle data of such type.

### DISCLOSURE OF THE INVENTION

An information lease management system according to the present invention is directed to a system for managing lease of arbitrary information contents to be distributed from an information lease service provider to a user, the system comprising: an information lease management apparatus for adding utilization condition information concerning lease of information contents to information contents, and processing the information so as to be distributed to the user; an information processing apparatus for receiving information contents with utilization condition information distributed from the information lease management apparatus; and communication means for connecting the information lease management apparatus and information processing apparatus, wherein the information processing apparatus is managed so as to automatically erasing the received information contents by using communication means based on the utilization condition information.

According to the information lease management system, in the case of management lease of arbitrary information contents distributed from an information lease service provider to a user, the information lease management apparatus and information processing apparatus are connected to each other by communication means. On one hand, the utilization condition information concerning lease of information contents is added to information contents by means of the information lease management apparatus, and then, is processed so as to be distributed to the user. On the other hand, the information contents with utilization condition information distributed from the information lease management apparatus are received and leased by the information processing apparatus. In the information processing apparatus, for example, when a lease period has expired, the leased information contents are managed so as to be automatically erased based on utilization condition information.

Therefore, a rental video system, a rental electronic library system, or a home use communication karaoke system or the like using Internet or communication lines such as telephone lines or satellite communication lines can be constructed. Moreover, a rigid copyright management mechanism in which an illegal copy is difficult can be provided.

An information lease management apparatus according to the present invention is directed to an apparatus for managing lease of information contents distributed from an information lease service provider to a user, the apparatus comprising: data processing means for adding utilization condition information concerning information lease to a user to information contents; and transmission and reception means for distributing the information contents having the utilization condition information added thereto to a user by the data processing means or receiving response information from the user.

According to the information lease management apparatus, in the case of managing lease of information contents distributed from the information lease service provider to the user, the utilization condition information concerning information lease to the user is added to information contents by the data processing means. The information contents with utilization condition information produced by the data processing means are distributed to the user by the transmission and reception means.

Therefore, the user can receive and rent information contents with utilization condition information distributed from the information lease management apparatus. This contributes to construction of an information lease management system for, when the lease period has expired, the rented information contents automatically erase the rented information conditions based on the utilization condition information.

The information processing apparatus according to the present invention is directed to an apparatus for receiving information contents leased from an information lease service provider to a user, the apparatus comprising: transmission and reception means for receiving information contents having added thereto utilization condition information concerning information lease to the user; data processing means for processing information contents received by the transmission and reception means; and a recording medium connectable to the data processing means in order to store information contents, wherein the data processing means is provided so as to automatically erase information contents stored in a recording medium based on the utilization condition information.

According to the information processing apparatus, in the case of receiving information contents leased from the information lease service provider to the user, the information contents having added thereto utilization condition information concerning information lease to the user are received by the transmission and reception means. The information contents received by the transmission and reception means are stored in a recording medium connectable to the data processing means. The data processing means is provided so as to automatically erase information contents from the inside of the recording medium based on the utilization condition information.

Therefore, this can contribute to construction of an information lease management system such that, when the lease period has expired, the rented information contents are automatically erased based on utilization condition information. Moreover, a rigid copyright management mechanism in which an illegal copy is difficult can be provided.

An information lease management method according to the present invention is directed to a method of managing lease of information contents distributed from an information lease service provider to a user by using communication means, wherein a contract concerning lease of information contents is made in advance between the information lease service provider and the user, utilization condition information is added to information contents to be distributed to the user based on the contrast on one hand, information contents having utilization condition information added thereto are received on the other hand, the received information contents are stored in a recording medium with its automatically erasable time limit storage function, and then, the information contents stored in the recording medium is automatically erased based on the utilization condition information.

According to the information lease management method, there can be constructed a rental video system, a rental electronic library system, or a home use communication karaoke system and the like using Internet or communication lines such as telephone line or satellite communication lines. Moreover, a rigid copyright management mechanism in which an illegal copy is difficult can be provided.

A recording medium according to the present invention is directed to a recording medium for recording information contents with utilization condition information leased from an information lease service provider to a user, wherein, when a predetermined lease period has expired, the information contents stored in the recording medium is automatically erased based on the utilization condition information.

According to the recording medium, a rigid copyright management mechanism in which an illegal copy is difficult can be provided.

### BRIEF DESCRIPTION OF THE DRAWINGS

FIG. 1 is a block diagram depicting an exemplary configuration of an information lease management system 10 according to one embodiment of the present invention;

FIG. 2 is a flow chart showing an example of processing in the information lease management system 10 shown in FIG. 1;

FIG. 3 is a block diagram depicting an exemplary configuration of a rental video distribution management system 100 according to each of the embodiments of the present invention;

FIG. 4 is a block diagram depicting an exemplary internal configuration of a home audio/visual (AV) server 20 according to a first embodiment;

FIG. 5 is a perspective view showing an appearance example (upper face side) of a hard disk drive (HDD) unit 40;

FIG. 6 is a perspective view showing an appearance example (bottom face side) of the HDD unit 40 shown in FIG. 5;

FIG. 7 is a block diagram depicting an exemplary internal configure of the HDD unit 40 shown in FIG. 5;

FIG. 8 is an imaginary view showing an example of mounting a connection connector 50 on a server main unit side and the HDD unit 40;

FIG. 9 is an imaginary view showing an exemplary configuration of the periphery of a connection connector 50 when the HDD unit is mounted;

FIG. 10 is an imaginary view showing an exemplary configuration when the HDD unit 40 is removed;

FIG. 11A is an example showing power supply waveforms when the HDD unit 40 is inserted and removed, FIG. 11B is an example showing voltage waveforms of an automatic erasure control terminal 45 of the HDD unit, FIG. 11C is an example showing voltage waveforms of a power supply control electrode pattern 49 of the HDD unit, and FIG. 11D is a timing chart showing each of the voltage waveform examples of a power supply control terminal 44 of the HDD unit 44;

FIG. 12 is a flow chart showing an example of processing when the HDD unit 40 is inserted and removed;

FIG. 13 is a block diagram depicting an exemplary internal configuration of a home AV server 200 according to a second embodiment;

FIG. 14 is a monitor image view showing a display example during initial setting of the HDD unit 40;

FIG. 15 is a monitor image view showing a display example when the HDD unit 40 shown in FIG. 14 is changed or set;

FIG. 16 is a flow chart showing a first example of processing in the home AV server 200 during reception and reproduction processing;

FIG. 17 is a flow chart showing a second example of processing in the home AV server 200 during reception and reproduction processing;

FIG. 18 is a flow chart showing a third example of processing in the home AV server 200 during reception and reproduction processing;

FIG. 19A is a display example before change of a startup screen P1, FIG. 19B is a display example after the change, FIG. 19C is a display example before change of a recorded video list screen P2, FIG. 19D is a display example after the change, FIG. 19E is a display example before change of a lease period setting screen P3, and FIG. 19F is a monitor image view showing each of the display examples after the change;

FIG. 20A is a display example of a download display screen P4 on a monitor screen, FIG. 20B is a display example of a download completion screen P5. FIG. 20C is a display example before change of a reproduction check screen P6, FIG. 20D is a display example of the change, FIG. 20E is a display example before change of a rental video search screen P7, and FIG. 20F is a monitor image view showing each of the display examples after the change;

FIG. 21A is a display example of a lease period expansion setting screen P8, FIG. 21B is a display example of an expansion check screen P9, FIG. 21C is a display example of an age limitation program screen P10, and FIG. 21D is a monitor image screen showing each of the display examples of an adult video listing screen P11.

### BEST MODE FOR CARRYING OUT THE INVENTION

Hereinafter, the present invention has been made to solve such conventional problems. It is an object of the present invention to provide an information lease management system, an information lease management apparatus, an information processing apparatus, an information lease management method and a recording medium, that are capable of making best use of a structure of the recording medium so as to provide a rigid copyright management mechanism in which an illegal copy is difficult concerning information contents rented by using communication lines.

One embodiment of the information lease management system, information lease management apparatus, information processing apparatus, information lease management method and recording medium according to the present invention will be described with reference to the accompanying drawings.

(1) Preferred Embodiments

In the present embodiments, there is provided an information processing apparatus for receiving information contents with utilization condition information, wherein information contents rented by using communication means are automatically erased based on utilization condition information. In the present invention, there can be constructed a rental video system, a rental electronic library system, or a home use communication karaoke system or the like using Internet or communication lines such as telephone lines or satellite communication lines, and there can be provided a rigid copyright management mechanism in which an illegal copy is difficult.

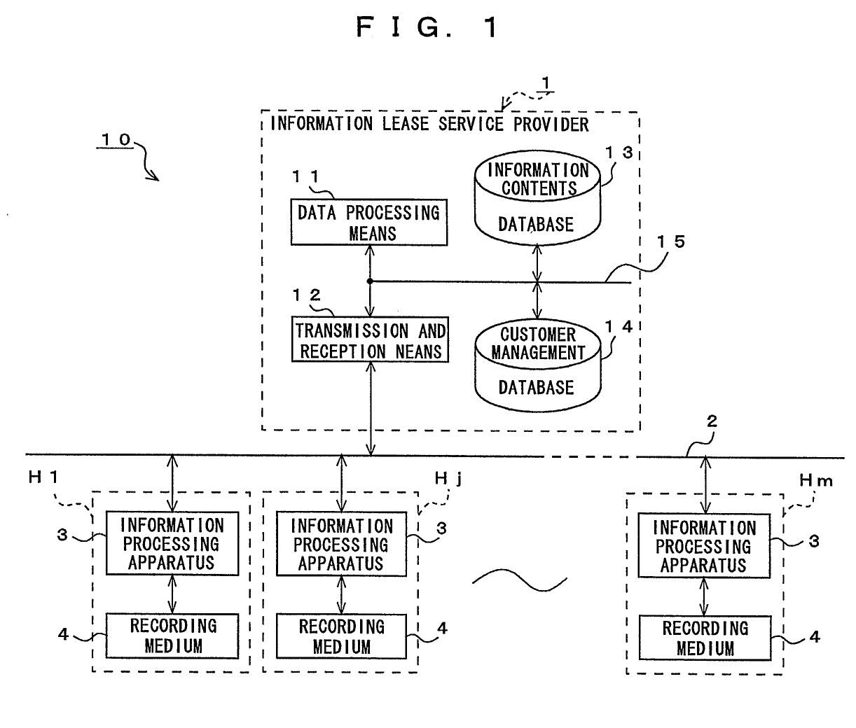

An information lease management system 10 shown in FIG. 1 is a system of managing lease of arbitrary information contents distributed from an information lease service provider to a person who desires utilization of information contents (hereinafter, simply referred to as “user”) Hj (j=1 to m). Specific examples of information contents include audio video (A & V) data, electronic library data, communication karaoke data or the like. The information contents may be basic element data required for designing machines or electric equipment as well as digital video data.

In order to receive services of this system 10, a user Hj is introduced so as to make a contract concerning lease of information contents in advance between the user and an information lease service provider. The contract contents include the lease period of information contents, lease charge, age limitation, and settlement method or the like. This contract is made to perform procedures on simple communication lines.

In this system 10, an information lease management apparatus 1 is provided at an information lease service provider side so as to manage lease of information contents distributed from the information lease provider to the user Hj. For example, utilization condition information concerning lease of the information contents is added to the information contents, and is processed so as to be distributed to the user Hj. The utilization condition information includes the lease period of information contents determined in accordance with a contract, the lease charge, the age limitation, and the settlement method or the like. The information lease management apparatus 1 is connected to communication means 2 such as Internet, telephone lines, satellite communication lines or leased communication lines for use.

The information lease management apparatus 1 comprises at least data processing means 11 connected to a system bus 15, transmission and reception means 12, information contents database 13 and customer management database 14. The data processing means 11 is provided so as to add the utilization condition information concerning information lease to the user Hj to the information contents. In addition, the data processing means 11 is provided so that there are integrally managed titles of information contents, the lease charge and lease period, and a list of users Hj.

In addition, with respect to information lease to the user Hj, in the case where the information contents are distributed with charge, and in the case where an amount of the upper limit of money for utilization charge is set in advance in accordance with a contract, the data processing means 11 is provided so that there is obtained at least a cumulative utilization charge in which the lease charges of information conditions are cumulated. Then, the upper limit of an amount of money and the cumulative utilization charge are compared with each other. In the case where the cumulative utilization exceeds the upper limit of an amount of money, the rejection of lease of information contents or change of the upper limit of an amount of money is presented in consideration of a financial state of the user Hj.

A general personal computer is used for this data processing means 11. The information contents with utilization condition information are encoded in advance by data processing means 11, whereby predetermined compression processing may be performed. The theft of information contents can be prevented by this processing.

Transmission and reception means 12 is connected to the data processing means 11 through a system bus 15, and information contents having utilization condition information added thereto are distributed to the user Hj by this data processing means 11. In addition, the transmission and reception means 12 is provided so as to receive response information from the user Hj. A general communication modem is used for the transmission and reception means 12. The response information from the user Hj includes a user name, a password number, a return date and time, a value of setting an upper limit of amount of money, or the presence or absence of lease expansion of information contents and the like. These items of response information are recorded in a database 14. Of course, the response information from the user Hj is organized in the form of a table by using an edit function. The contents recorded in this table include a customer management number, a user name, a password number, an information content code, a lease period, a value of setting the upper limit of an amount of money, a cumulative value of an amount of money for utilization charge, and the presence or absence of lease expansion of information contents.

Information contents to be leased to the user Hj are stored in a database 13. In the case where an information lease service corresponds to a rental video service, a rental video code, a tile, and audio/video data or the like are stored as its information contents. In the case where the service of such type corresponds to an electronic library service, an electronic library code, a tile, and electronic library data or the like are stored. In the case where the service of such type corresponds to a communication karaoke service, a communication karaoke code, a title, and karaoke data or the like are stored.

In the present embodiment, menu screen information is provided to the user Hj during a contract. The menu screen information is organized by sampling a title of information contents from the database 13. This is because the search of information contents are facilitated for the user Hj.

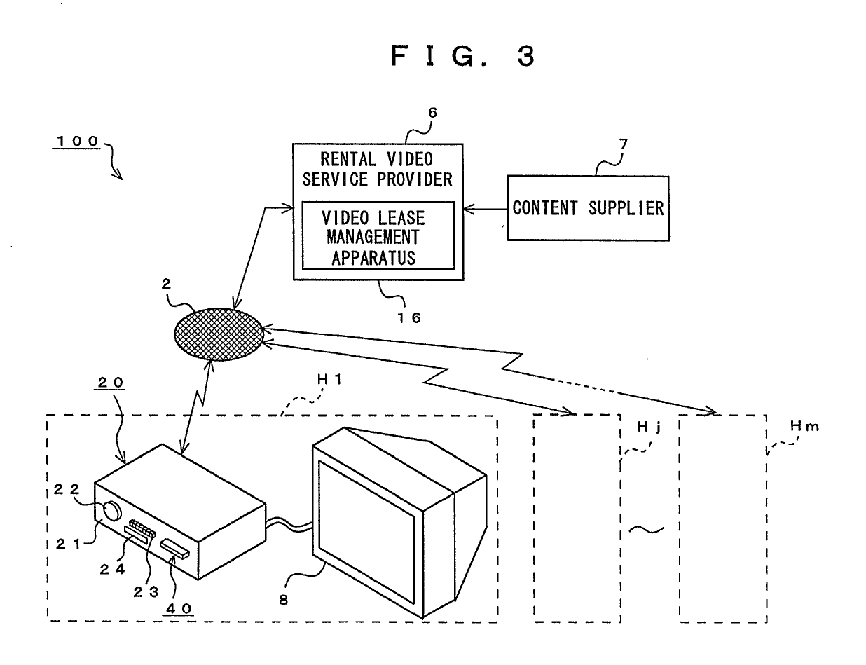

On the other hand, an information processing apparatus 3 such as home AV server is provided at the user side, and the information processing apparatus 3 and information lease management apparatus 1 are connected to each other by the above described communication means 2 so that the information contents with utilization condition information distributed from this information lease management apparatus 1 are received and rented. The home AV server will be described with reference to FIG. 3. It is presumed that this information processing apparatus 3 is managed so as to automatically erase the information contents rented by using the communication means 2 based on the utilization condition information.

For example, a recording medium 4 with its time limit storage function that can be automatically erased is mounted on the information processing apparatus 3, and the information contents downloaded from the information lease management apparatus 1 is stored. In addition, when the lease period has expired, the rented information contents are automatically erased based on the utilization condition information. Of course, this recording medium 4 comprises a data erasure mechanism such that, when the recording medium 4 is removed from the information processing apparatus 3, the information contents are automatically erased. This data erasure mechanism will be described with reference to FIG. 3 to FIG. 12.

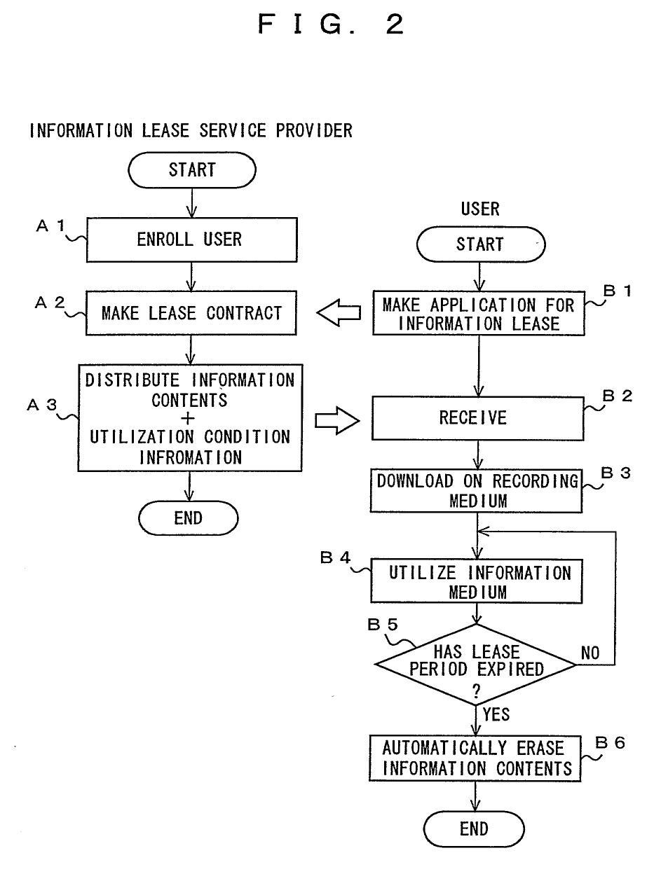

Now, an example of processing in the information lease management system 10 will be described with respect to an information lease management method according to the present embodiment. FIG. 2 is a flow chart showing an example of processing in the information lease management system 10.

The present embodiment presumes a case in which the lease of information contents distributed from an information lease service provider to a user Hj is managed by using communication means 2 such as Internet, telephone lines, satellite communication lines or leased communication lines. At the receiver side, a recording medium 4 with its time limit storage functions that can be automatically erased is mounted to an information processing apparatus 3. When a recording medium 4 is removed from this information processing apparatus 3, the information contents stored in the recording medium 4 are organized to be automatically erased. The information contents to be leased to the user Hj are stored in the database 13. However, with respect to information contents of which an information lease service provider does not have its copyright, a copyright use license agreement are made among the lease service providers, a video software manufacturer, and a cinema supplier or the like.

With this being presumed, at the information lease service provider side, the users Hj of information contents are enrolled at the step A1 in the flow chart shown in FIG. 2. This enrollment may be performed by advertisement over Internet. Of course, the enrollment may be advertised on newspaper.

A user who saw the above enrollment makes an application of information lease to an information lease service provider at the step B1. During this application, the information lease management apparatus 1 and information processing apparatus 3 are connected to each other by communication means 2. At the information lease service provider receiving this application, a lease contract with the user Hj is made at the step A2. With respect to a plurality of information contents to be leased to the user Hj, the user Hj is presented with index information.

For example, a menu screen is displayed on a user's monitor. The menu screen displays a video image describing a title of information contents. The user Hj is organized to make a response by using an information processing apparatus 3 so as to distribute arbitrary information conditions selected from this menu screen. In addition, the lease charge of the information contents, the age limitation, and the settlement method or the like are presented.

Of course, with respect to the contract on information lease, the user is organized so as to arbitrarily input the lease period of information contents, password number relevant to age limitation, settlement method or the like. Depending on the contents of the contract, the memory size or disk capacity and the like of a recording medium 4 is increased or decreased (flexibility of contract contents). The user can make a lease contract by the number of files that can be downloaded at one time. In addition, with respect to the lease contract, the upper limit of an amount of money for utilization charge of information contents can be set. Further, with respect to the lease of information contents, for example, in the case where age limitation such as adult video is set, the user Hj is organized so as to register a password number in advance.

When utilization condition information is added to information contents by data processing means 11 at the information lease service provider side, the information contents with utilization condition information are organized so as to be distributed to the user Hj by transmission and reception means 12 at the step A3. At the user side receiving information distribution from this information lease management apparatus 1, the information contents with utilization condition information are received by the information processing apparatus 3 at the step B2. Then, processing goes to the step B3 at which information contents with utilization condition information are recorded in the recording medium 4 so that the user Hj can rent its information contents. Then, at the step B4, the user Hj reproduces information contents during the lease period any time, so that the information contents are provided for audio or visual utilization.

Then, processing goes to the step B5 at which it is checked whether or not the lease period has expired. This check is made by control means provided in the recording medium 4. For example, in the control means, the lease expiration and current date and time information are compared with each other by utilizing a calendar function. In the case where the return date and time and the current date and time are coincident with each other as a result of this comparison, a time limit management is provides such that the information contents stored in the recording medium 4 are automatically erased. This time limit management may be performed by the information processing apparatus 3. In the case where the lease period has not expired, processing goes to the step B4 at which information conditions are continuously utilized. In the case where the lease period has expired, processing goes to the step B6 at which the information contents are managed in the information processing apparatus 3 so as to be automatically erased based on utilization condition information.

In the case where the upper limit of an amount of money is set relevant to the lease of information contents, and in the case where an application of a least contract is made again at the step A2, at least a cumulative utilization charge in which the lease charge of information contents is obtained at the information lease management apparatus 1. In the case where this upper limit of an amount of money and the cumulative utilization charge are compared with each other, and the cumulative utilization charge exceeds the upper limit of an amount of money, the rejection of lease of information contents or a change of the upper limit of an amount of money is presented.

In addition, with respect to the lease of information contents, at the step A2, in the case of renting information contents such as adult video in which age limitation is set, a user registered password is input in advance. Further, upon expiration of the lease period of information contents, a selection is made as to whether or not the lease period of information contents is expanded. At the information lease service provider, based on response information from the user Hj, a customer management number, a user name, a password number, information content code, lease expiration, a value of setting the upper limit of an amount of money, a cumulative value of an amount of money for utilization charge, and the presence or absence of lease expansion of information contents or the like are edited and intensively managed in the form of listings.

Therefore, unlike a conventional system, the user Hj can receive and rent information contents with utilization condition information distributed from the information lease management apparatus 1 through communication means 2 without visiting rental video shop or the like. Moreover, there can be constructed an information lease management system such that, when the lease period has expired, the rented information contents are automatically erased based on utilization condition information.

In this manner, there can be constructed a rental video system, a rental electronic library system, and a home-used communication karaoke system or the like using Internet or communication lines such as telephone lines and satellite communication lines. The contents reserved for the information lease management apparatus 1 include information contents that can be used for remote class or the like. Moreover, when a storage medium 4 is removed from this information processing apparatus 3, the information contents stored in the recording medium 4 is automatically erased so that there can be achieved a rigid information lease business model with its copyright management mechanism in which an illegal copy is difficult.

(2) Embodiments

FIG. 3 is a block diagram depicting an exemplary configuration of a rental video distribution management system 100 according to embodiments of the present invention.

In this example, a rental video service provider home page is opened over Internet. Then, a rental video service provider is organized to provide recorded video data or rental video data and the like. A home AV server and monitor is provided as an information processing apparatus at each home. At each home, rental video data with utilization condition information or the like is received and rented at each home by using communication means so that, when the lease period has expired, thus rented rental video data is organized to be automatically erased based on the utilization condition information. In addition to this, a rigid rental video distribution management system with its copyright management mechanism in which an illegal copy is difficult can be provided.

The rental video distribution management system 100 shown in FIG. 3 is connected to a rental video service provider 6 and each home (user) Hj by communication means 2. Then, rental video data with utilization condition information is distributed from the rental video service provider 6 to a home AV server 20 of each home Hj (j=1 to m).

In this example, the utilization condition information contains first to third control programs. The first control program corresponds to data for selecting whether or not the lease period of rental video data is extended. The second control program corresponds to data for input predetermined registered password numbers. The third control program corresponds to data for inputting the lease period of rental video data in the case where the lease period of rental video data is arbitrary set.

At this rental video service provider 6, there is provided a video lease management apparatus 16 that is shown as an example of the information lease management apparatus 1. An exemplary internal configuration of the video lease management apparatus 16 is similar to that of the information lease management apparatus 1 described in FIG. 1, and the information contents are provided by reading them with rental video data. Rental video data with utilization condition information is encoded in advance by the video lease management apparatus 16 to be compression data in accordance with MPEG system or the like.

At each home Hj that is a user of this rental video data, there is provided at least a home AV server 20 and a monitor 8 that are an example of the information processing apparatus. At each home Hj, rental video data with utilization condition information is received and rented by using communication means 2. Then, at each home Hj, the thus rented rental video data is automatically erased based on the utilization condition information when the lease period has expired (time shift function).

This home AV server 20 comprises: an image operation function caused by dedicated BOX processing; a rigid copyright management mechanism; a billing management mechanism; a time limit management mechanism of rental video data caused by a key management code; its audio/visual restriction mechanism; an illegal copy protection function caused by encoding rental video data; an automatic time management function; a calendar adjustment function or the like. By these functions, illegal time limit management is prevented.

This home AV server 20 is provided so as to receive rental video data leased from a rental video service provider 6 to a user Hj and reproduce the data. In addition, there are provided general TV broadcast reception and reproduction, reproduction of a recorded video, shopping data reproduction, video image reproduction during Internet access, video image reproduction during video reservation or the like. A monitor 8 is provided as an example so as to display index information concerning rental video data. At least a menu screen describing rental video data titles is displayed on the monitor 8.

A front panel 21 is provided at a home AV server 20. Further, at this front panel 21, a rotary operating portion (rotary encoder) 22 or a plurality of switches 23 is provided, and is operated so as to input setting information concerning the lease of rental video data. For example, there are input operation information such as the lease period of rental video data concerning an information lease contract, password numbers relevant to age limitation, and settlement method.

Further, with respect to the lease of rental video data, the upper limit of an amount of money for utilization charge of rental video data is set. In this example, a function possessed by the video lease management apparatus 16 may be incorporated in the home AV server 20. For example, at the home AV server 20, there is obtained at least cumulative utilization charge in which the lease charges of rental video data are accumulated. Then, at the server 20, this upper limit of an amount of money and the cumulative utilization charge are compared with each other. In the case where the cumulative utilization charge exceeds the upper limit of an amount of money, the rejection of access to the rental video service provider or a change of the upper limit of an amount of money may be presented (billing management mechanism).

In addition, a display device 24 such as LED is provided at the above described front panel 21 to be displayed based on an input situation of these items of operation information. In this example, a hard disk unit (hereinafter, referred to as HDD unit) 40 that is provided as an example of a recording medium with its time limit storage function that can be automatically erased is mounted on the right side of the front panel. The video lease management apparatus 16 is provided so as to distribute arbitrary rental video data selected on a menu screen to the HDD unit 40. Rental video data downloaded from this video lease management apparatus 16 is stored in the HDD unit 40. When the lease period has expired, the rented rental video data is automatically erased based on utilization condition information (time limit management mechanism).

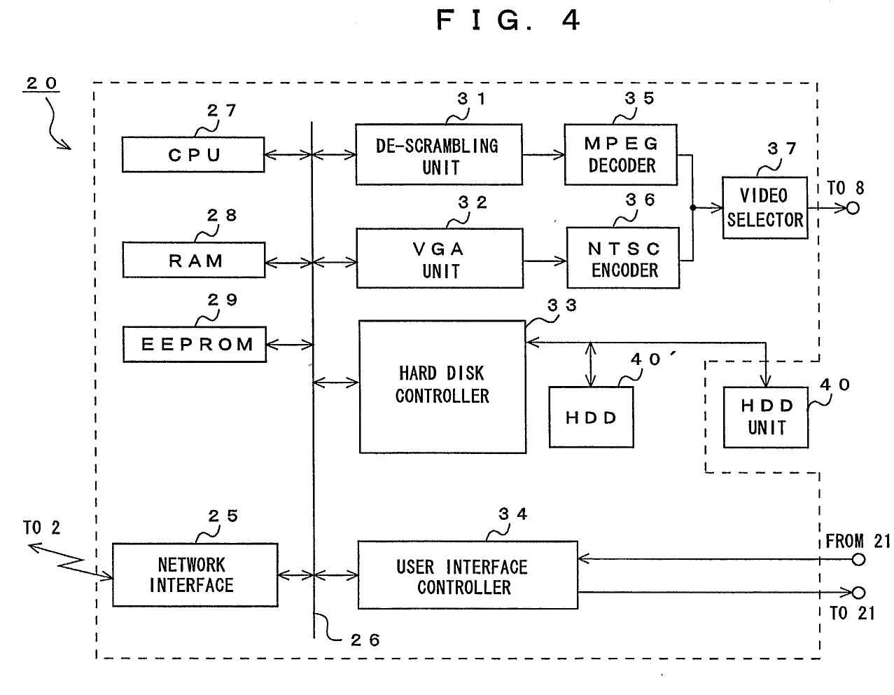

FIG. 4 is a block diagram depicting an exemplary internal configuration of a home AV server 20. The home AV server shown in FIG. 4 comprises a network interface 25 that is provided as an example of transmission and reception means. At the server 20, there is received rental video data having added thereto utilization condition information concerning information lease to the user Hj. In addition, at the server 20, it is organized that response information of the user is transmitted to the video lease management apparatus 16. A network interface 25 is connected to communication means 2 such as telephone line or Internet. At present, although a telephone line is mainly used, a satellite communication line, a wireless communication line, and a dedicated communication cable or the like are provided, and is selected by a user conveniently.

A system bus 26 is connected to this network interface 25. To this system bus 26, there are connected a CPU (Central Processing Unit) 27, a RAN 28, an EEPROM (read-only memory from which information is electrically written and erased) 29, a de-scrambling unit 31, a VGA (Video Graphics Array: flush memory) unit 32, a hard disk controller 33, and a user interface controller 24 or the like.

The CPU 27 is provided so as to control the entire server system. For example, the rental video data with utilization condition information, downloaded by the network interface 25 is organized to be transferred to the hard disk controller 33. At this time, a system control software program such as transfer control program or various set item information is stored in the EEPROM 29. This is because data requiring non-volatile properties are stored. Various set item information includes an image decoding key, an age limitation key, a lease period key, an upper limit charge per month, upper limit count per month, and simultaneous distribution enable count or the like.

A software program of such type or various set item information and the like is temporarily stored in a RAM 28 used as a working memory. Of course, rental video data with utilization condition information, downloaded by the network interface 25, may be temporarily stored in the RAM 28 or the like. Thus, the occupation time of the communication means 2 can be shortened, and the line use charge can be reduced.

In addition, the CPU 27 comprises a well known automatic time management mechanism and a calendar adjustment mechanism. For example, at the CPU 27, the lease period and the current date and time information are compared with each other by using the calendar function. In the case where the return date and time and the current date and time are coincident with each other, time limit management is performed such that the contents of rental video data in the HDD unit 40 are automatically erased. This time limit management may be performed by the CPU 53 incorporated in the HDD unit 40.

At the de-scrambling unit 31, the MPEG data decoded in advance at the transmission side is restored, whereby rental video data with utilization condition information is output in accordance with an MPEG system. An MPEG decoder 35 is connected to the de-scrambling unit 31, the MPEG compressed rental video data is expanded, and an analog video signal is demodulated (illegal copy protection mechanism).

In addition, the VGA unit 32 is connected to the system bus 26 so as to output image data based on menu screen information provided from the video lease management apparatus 16. An NTSC encoder 36 is connected to the VGA unit 32 so as to convert image data such as menu screen information into the TV video image signal in accordance with the NTSC system. A video selector 37 is connected to these MPEG decoder 35 and NYSC encoder 36, and a rental video image and a menu image are switched each other under the control of the CPU 27 so as to be output to the monitor 8.

Further, a user interface controller 34 is connected to the system bus 26 to manage operation information produced by an infrared-ray remote controller (not shown) or operation information produced by a function switch 23 or the like of the front panel 21 shown in FIG. 3, and then, notify the CPU 27 of the input state of these items of operation information. In this example, the user interfaces are only the infrared-ray remote controller and the switch 23 of the front panel 21, thus making it impossible for the user to illegally operate an internal file of the HDD unit 40 that is provided as an example of a recording medium. Therefore, resistance against illegal copy of the HDD unit 40 can be strengthened. At this front panel 21, a display device 24 such as LED or the like is provided so as to cause display based on control data from the CPU 27.

An external HDD unit 40 is connected to the above described hard disk controller 33. At the HDD unit 40, rental video data with utilization condition information downloaded by the network interface 25 is stored upon receipt of transfer control of the hard disk controller 33.

This external HDD unit 40 provides a structure such that, when the HDD unit 40 is removed from the home AV server 20, the rental video data stored in this unit 40 is automatically erased. This is because an illegal copy of rental video data is made impossible. The recording medium is not limited to such external unit, and may be an incorporated hard disk (HDD) 40′ directly connected to the hard disk controller 33. The home AV server 20 is provided so as to automatically erase rental video data in the HDD unit 40 or 40′ based on utilization condition information.

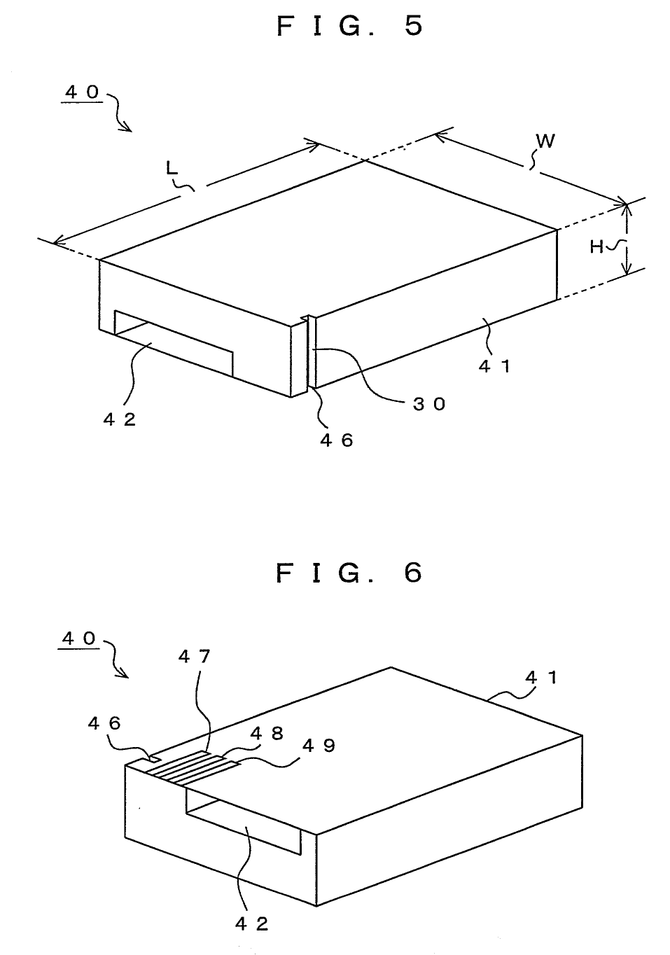

Now, an exemplary configuration of an external HDD unit 40 and an exemplary operation of the unit will be described here. FIG. 5 is a perspective view showing an appearance example (upper face side) of the HDD unit 40, and FIG. 6 is a perspective view showing another appearance view (bottom face side) of the unit.

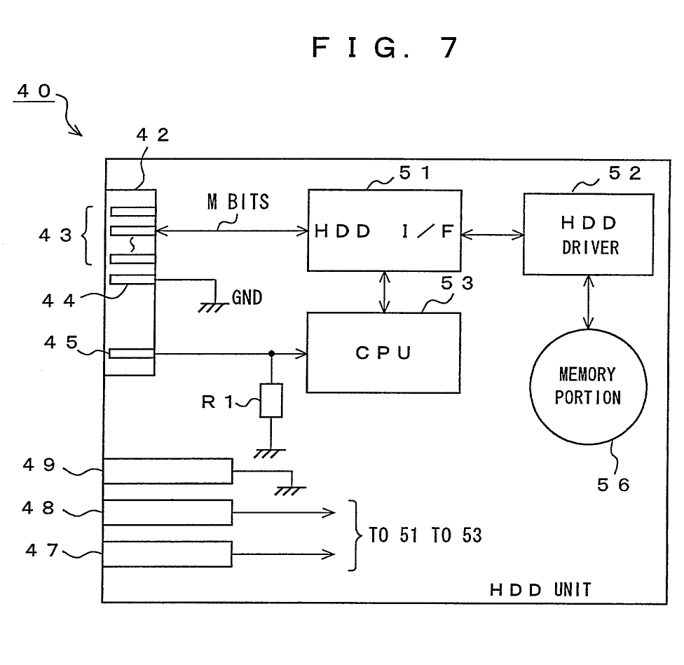

The HDD unit 40 shown in FIG. 5 has a flat box shaped mainframe 41 whose dimensions are L in length, W in width, and G in height. In FIG. 5, a terminal box 42 is provided at one end face of the mainframe 41. At the terminal box 42, there is provided a plurality of connectors (not shown) to be electrically connected to a server main body. These connectors each have a power supply control terminal 44 for detecting insertion or removal of the HDD unit 40, an automatic erasure control terminal 45, and M signal terminals 43 for inputting M-bit rental video data (Refer to FIG. 7).

A lock mechanism 30 is provided on the right side face of this terminal box 42 so that, when power supply to the HDD unit 40 is disconnected, the HDD unit 40 is fixed to the server main body. For example, a lock mechanism groove portion 46 is provided at the HDD unit 40. This groove portion 46 is designed to prevent the slip-off of the HDD unit 40 by accepting a projection portion (not shown) when the server main body is removed. This projection portion enters the groove portion 46 when the power supply is turned OFF by a lock release switch (not shown). In contrast, when the power supply is turned ON, the projection portion is used together with a solenoid or the like so as to be removed from the groove portion 46.

In addition, on the bottom face of the mainframe 41 shown in FIG. 6 and at the adjacent positions to the groove portion 46, there are provided power supply electrode patterns 47 and 48 and a power supply control electrode pattern 49. The power supply electrode patterns 47 and 48 are used to supply power to the HDD unit 40. The power supply electrode pattern 47 is provided at the grounding (GND) side, and the power supply electrode pattern 48 is provided at a LIVE side. The power control electrode pattern 49 is used to control a power supply when the HDD unit 40 is inserted and removed.

For example, the server main body monitors a potential of the power supply control electrode pattern 49. At a time when the potential being insertion and removal detection information is changed from a low level (hereinafter, referred to as level L) to a high level (hereinafter, referred to as level H), power supply to the HDD unit 40 is stopped. As a result, the rental video data (file) in the HDD unit 40 can be erased (data erasure mechanism). These three electrode patterns 47 to 49 are set to be relatively longer in order to operate an automatic erasure function with high reproduction, and to ensure a time for erasing a file in the HDD unit 40. For example, each of the electrode patterns 47 to 49 is set to about 20 to 30% of length L of the mainframe 41.

FIG. 7 is a block diagram depicting an exemplary internal configuration of the HDD unit 40. In FIG. 7, at a terminal box 42, there are provided: at least M signal terminals 43; and a power supply control terminal 44 and an automatic erasure control terminal 45 for detecting insertion and removal of the HDD unit 40 that is provided as an example of detection means, wherein the HDD unit 40 is removed from the server main body so that automatic file erasure is performed at these terminal potentials (illegal copy protection function). The power supply control terminal 44 is directly grounded on GND in the HDD unit 40, and an automatic erasure control terminal 45 is grounded through a pull-down resistor R1.

The power supply electrode patterns 47 and 48 are provided so as to supply the power supply from the server main body to an HDD interface (I/F) 51, an HDD driver 52 and a CPU 53 of the HDD unit 40. A power supply control electrode pattern 49 is grounded (GND) in the HDD unit 40. M signal terminals 43 are connected to the HDD interface (I/F) 51, and are used for writing and reading out M-bit rental video data.

The CPU 53 that is provided as an example of control means is connected to this HDD interface (I/F) 51 so that power supply to the HDD interface (I/F) 51 and HDD driver 52 is disconnected based on removal detection information produced by an automatic erasure control terminal 45. By this power supply disconnection, automatic erasure of rental video data is controlled. For example, the CPU 53 detects the potential of a resistor R1, whereby it is judged whether or not the HDD unit 40 is attached to the server main body. In the case where the HDD unit 40 is attached to the server main body, the CPU 53 detects a level H by means of the resistor R1 upon receipt of the power supply from the server main body.

In addition, in the case where the HDD unit 40 is removed from the server main body, the CPU 53 detects a level L by means of the resistor R1 upon receipt of the power supply disconnected to be delayed immediately after such removal. In this duration, the rental video data stored in the HDD unit 40 is automatically erased. An HDD driver 52 is connected to the HDD interface (I/F) 51, and a write signal produced by modulating M-bit rental video data is recorded in a memory portion 56. In addition, the HDD driver 52 modulates a readout signal read out from the memory portion 56 so as to output M-bit rental video data.

A non-volatile memory is used for the memory portion 56 so as to erase data in a limited erasure time by means of the HDD driver 52. In the case where a memory requiring a storage holding operation is used for the memory portion 56, the recording conditions can be automatically erased by disconnecting the power supply.

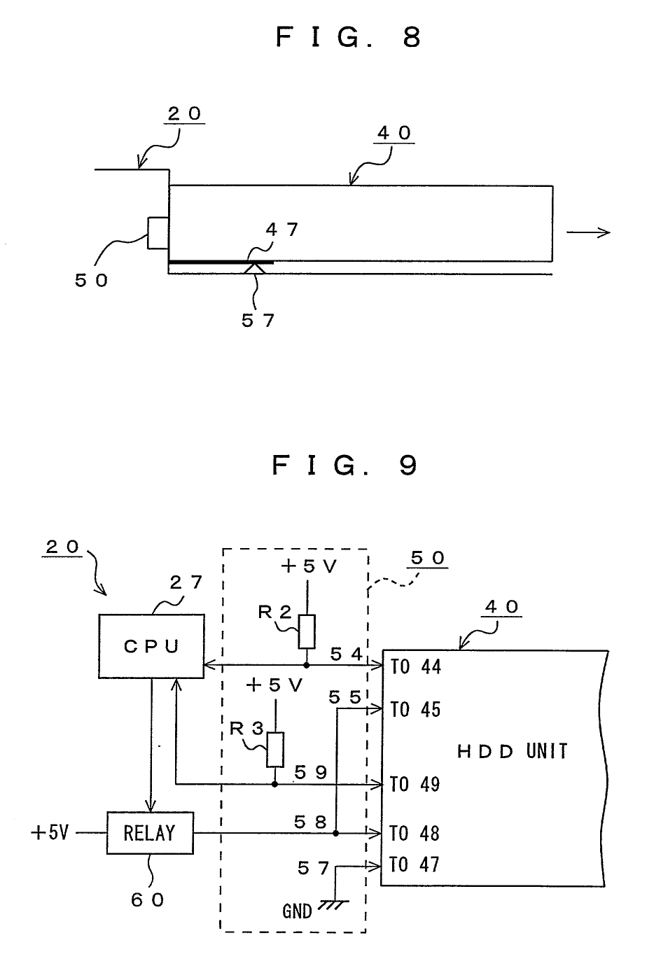

FIG. 8 is an imaginary view showing an example of attaching a main body side connection connector 50 to an HDD unit 40. When the HDD unit 40 shown in FIG. 8 is attached to the main body side connection connector 50, for example, a power supply electrode pattern 47 and a projection shaped main body side electrode 57 are connected to each other so that the power us supplied into the HDD unit 40. In this example, the main body side electrode 57 is located at a position near the right end of the power supply electrode pattern 47. This is because, when the HDD unit 40 is removed from the server main body, a time interval for the main body side electrode 57 coming into contact with the power supply electrode pattern 47 is extended. As a result, a time for erasing the rental video data in the HDD unit 40 can be ensured.

FIG. 9 is an imaginary view showing an exemplary configuration of the periphery of the connection connector 50 when the HDD unit is attached. The CPU 27 and a power supply control relay 60 are provided at the home AV server 20 shown in FIG. 9. A main body side control terminal 54 and a pull-up resistor R2 are connected to the CPU 27. In this example, when the main body side control terminal 54 and the power control terminal 44 of the HDD unit 40 are connected during attachment of the HDD unit, it is detected whether or not the HDD unit 40 is completely attached to the server main body.

Further, a main body side electrode 59 and a pull-up resistor R3 are connected to the CPU 27. During attachment of the HDD unit, when the main body side electrode 59 and the power supply control electrode pattern 49 of the HDD unit 40 are connected to each other, it is detected whether or not the HDD unit 40 starts attachment to the server main body. The relay 60 is connected to the CPU 27 so as to supply the power supply (+5V) from the server main body to the HDD unit 40.

A main body side control terminal 55 and a main body side electrode 58 are connected to this relay 60. When the HDD unit is attached, the main body side control terminal 55 and an automatic erasure control terminal 45 of the HDD unit 40 are connected to each other, and the main body side electrode 58 and its power supply electrode pattern 48 are connected to each other. The main body side electrode 57 is a ground (GND) of the server main body side, and the main body side electrode 57 is connected to the power supply electrode pattern 47 when the HDD unit is mounted.

FIG. 10 is. an imaginary view showing an exemplary configuration when the HDD unit 40 is removed. When the HDD unit 40 shown in FIG. 10 is removed from the main body side connection connector 50, for example, the terminal box 42 of the HDD unit 40 is removed from the main body connection connector 50 while a contact state between the power supply electrode pattern 47 and a projection shaped main body side electrode 57 is maintained. In this case as well, the power supply from the server main body is supplied in the HDD unit 40. In this example, power is supplied until the main body side electrode 57 has reached the left end of the power supply electrode pattern 47. Using this period, the rental video data stored in the HDD unit 40 is erased.

Now, exemplary operation during insertion and removal of the HDD unit 40 will be described here. This example presumes a case in which a lock release switch (not shown) is pressed, and the HDD unit 40 is removed. The CPU 27 detects potentials of the resistors R2 and R3 in order to make automatic erasure control in the HDD unit 40, whereby it is judged whether or not the HDD unit 40 is attached to the server main body.

### OPERATION EXAMPLE WHEN HDD UNIT IS ATTACHED

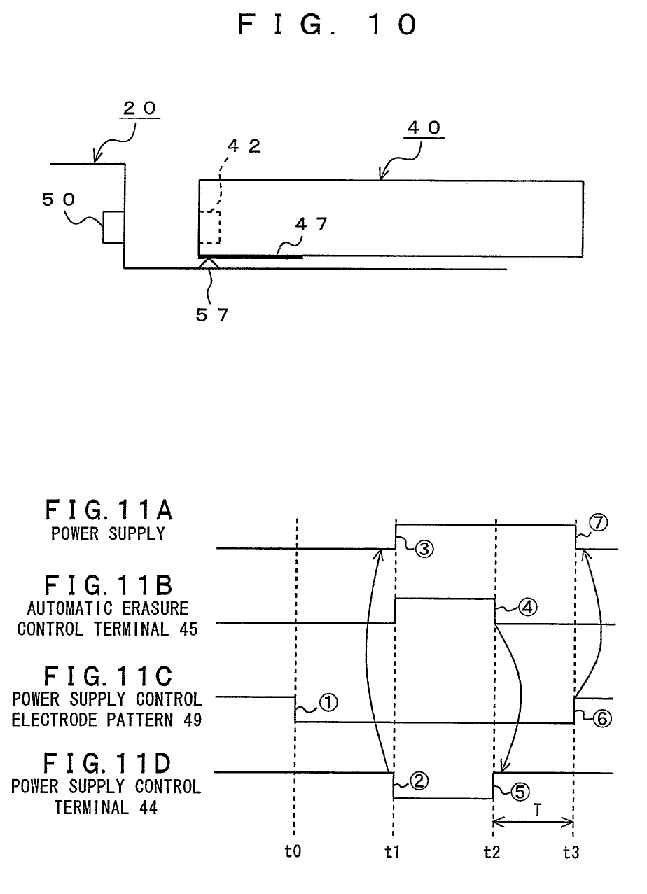

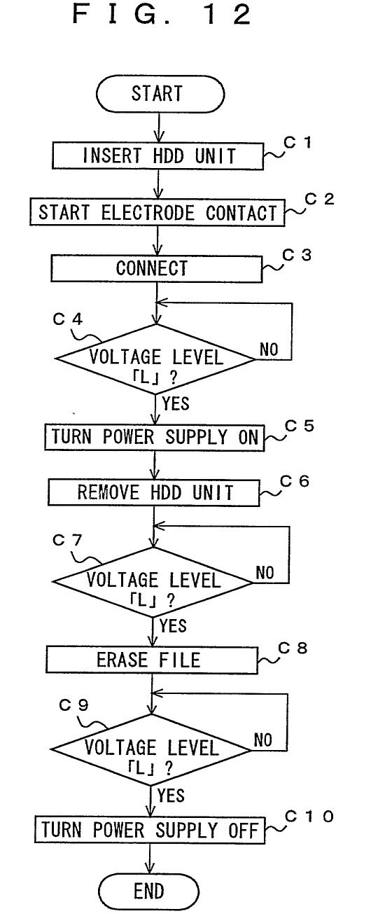

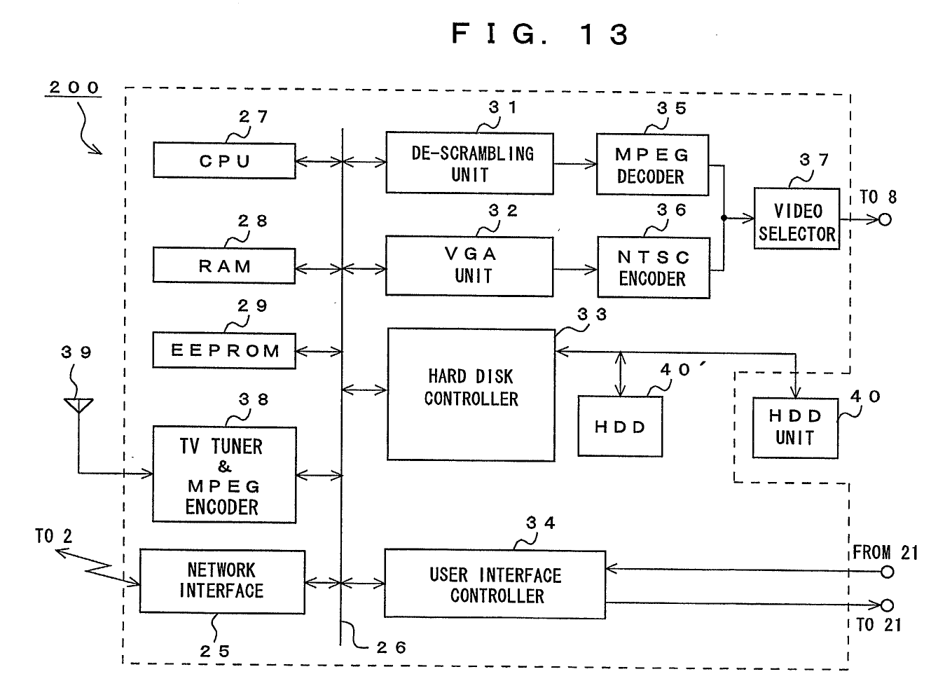

First, at a time “t0” of a time chart shown in FIG. 11C and at the step C1 in the flow chart shown in FIG. 12, the HDD unit 40 is inserted into the server main body. Through this insertion, at the step C2, the main body side electrode 57 is connected in contact with the power supply electrode pattern 47 earlier as compared with each of the terminals 43, 44 and 45 in the terminal box 42. Similarly, the main body side electrode 58 and the power supply electrode pattern 48 are connected to each other. Then, at a timing of <1> shown in FIG. 11C, the main body side electrode 59 and the power supply control electrode pattern 49 are connected to each other. However, at this time, the relay 60 is turned OFF, and thus, the power is not supplied to the power supply electrode pattern 48.

At the CPU 27 of this server main body, there is provided a main body side electrode 54 for connecting the power supply control terminal 44. In general, the main body side electrode 54 is pulled up to a level H. Therefore, when the HDD unit 40 is deeply inserted into the server main body, each terminal 43 in the terminal box 42 is connected at a time “t1” in the time chart shown in FIG. 11D and at the step C3 shown in FIG. 12. In addition, the main body side control terminal 54 is connected to the power supply control terminal 44, and the main body side control terminal 55 is connected to the automatic erasure control terminal 45, respectively.

Then, at the step C4, it is detected whether or not the potential level L obtained by the resistor R2 is changed to the level L at the CPU 27. At a timing of <2> shown in FIG. 11D, it is detected that the potential caused by the resistor R2 is changed from the level H to the level L. Based on this detection result, the CPU 27 can recognize that the HDD unit 40 is attached to the service main body. When the main body side electrode 54 enters the level L, the CPU 27 judges that the HDD unit 40 is connected at a timing of <3> shown in FIG. 11A and at the step C5 shown in FIG. 12. Then, the CPU 27 turns ON the relay 60 so as to supply the power supply (+5V) from the server main body into the HDD unit 40 through the main body side electrode 58 and power supply electrode pattern 48.

At the same time as the above operation, the change from the level L to the level H by the resistor R1 is detected by the CPU 53. Based on the detection result, the CPU 53 can control the HDD interface 51 and the HDD unit 52. In the CPU 27, while the HDD unit 40 is attached to the server main body, the power supply control terminal 44 of the HDD unit 40 and the level L of the power supply control pattern 49 are detected.

### OPERATION EXAMPLE WHEN HDD UNIT IS REMOVED

When the HDD unit 40 is removed at a time “t2” in the time chart shown in FIG. 11B and at the step C6 in the flow chart shown in FIG. 12, each of the terminals 43, 44 and 45 in the terminal box 42 is removed from the main body side connection connector 50. Immediately after the HDD unit 40 is removed from the server main body, the CPU 27 detects the level H by means of the resistor R2 and the level L of the power supply control pattern 49 of the HDD unit 40. At a timing of <4> shown in FIG. 11B and at the step C7 shown in FIG. 12, the potential of the automatic erasure control terminal 45 is detected in the HDD unit 40 by means of the CPU 53. At this time, the automatic erasure control terminal 45 is removed from the main body side connection connector 50, whereby the potential caused by the resistor R1 falls into the level L.

On the other hand, the power supply electrode patterns 47 and 48 of the HDD unit 40 and the power control electrode pattern 49 each are structured to be long as compared with each of the terminals 43, 44 and 45 in the terminal box 42. Thus, at this time, the CPU 27 still keeps ON the relay 60 ON, and thus, the power is supplied to the HDD unit 40 through the power supply electrode patterns 47 and 48 (time difference driving method).

Therefore, the CPU 53 can detect a potential change of the automatic erasure control terminal 45. In the case where the HDD unit 40 is set to an automatic erasure type, when this potential of the automatic erasure control terminal 45 falls into the level L, the CPU 53 is provided so as to erase a file in a memory portion 56 at a timing of <5> shown in FIG. 11D and at the step C8 shown in FIG. 12. When the erasure time is defined as T, an equation of T=t3−t2 is established.

Further, when the HDD unit 40 is removed, the power supply control electrode pattern 49 is released from the main body side electrode 59. At this time, in the CPU 27, at the level H caused by the resistor R2, at a timing of <6> shown in FIG. 11C, and at the step C9 shown in FIG. 12, a potential of the main body side electrode 59 is detected. The level H caused by the resistor R3 is detected by the CPU 27, processing goes to a timing of <7> shown in FIG. 11A and step C10 at which the CPU 27 turns OFF the relay 60 so as to stop power supply to the HDD unit 40 (data erasure mechanism).

### SECOND EXAMPLE

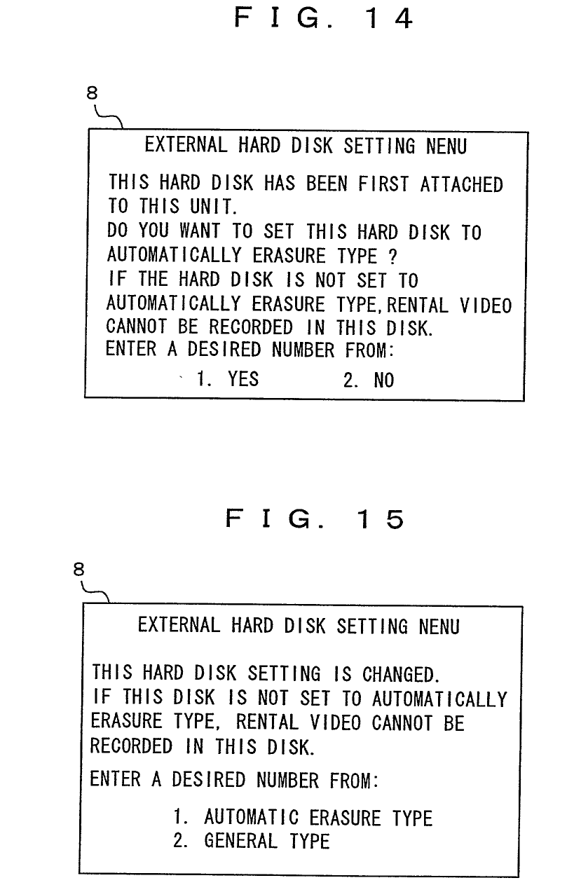

FIG. 13 is a block diagram depicting an exemplary configuration of a home AV server 200 according to a second example of the present invention. In this example, a TV tuner and encoder 38 are added to the home AV server 200 shown in FIG. 4. The same reference numerals and elements as those in the first embodiment have the same function. A description of these elements is omitted here.

In the home AV server 200 shown in FIG. 13, the TV tuner and encoder 38 is connected to an antenna 39, and a general TV broadcast signal received from this antenna 39 is encoded so as to be recorded in the HDD unit 40. In this case, a famous cinema with its copyright distributed from a broadcast station or the like can be distributed to a user during the predetermined lease period by applying the information lease management method described in the first embodiment.

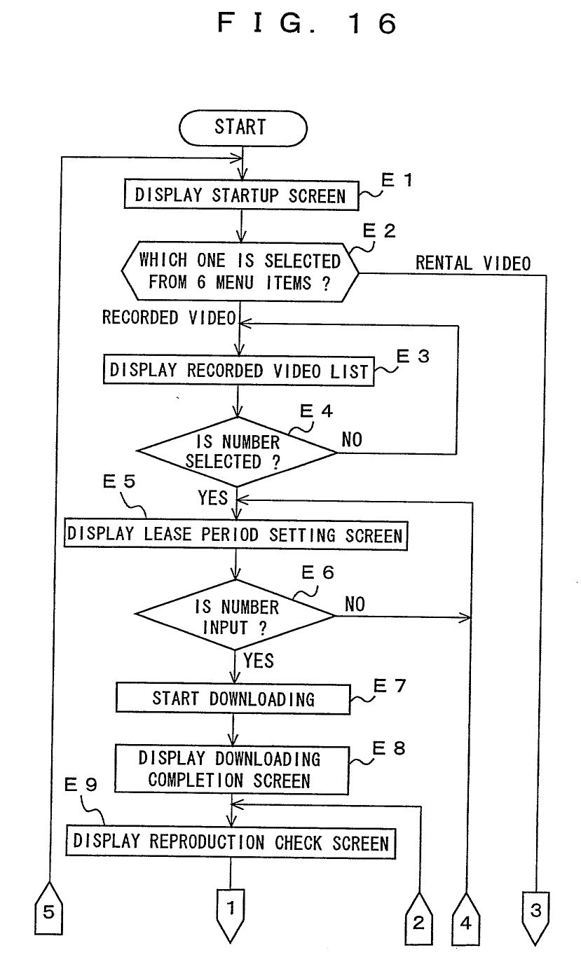

Now, an example of processing relevant to a home AV server 200 according to the present invention will be described here. In this example, when an automatic erasure type external HDD unit 40 is first attached to the home AV server 200, an “external hard disk setting menu” as shown in FIG. 14 is displayed on a monitor 8 or the like shown in FIG. 3. At this time, the following message is displayed on the monitor screen.

“This hard disk is first attached to this unit.

Do you want to set this hard disk to automatic erasure type?

If you do not set the hard disk to automatic erasure type, a rental video cannot be recorded in this disk.

Enter your desired number from:

1. Yes 2. No.”

The user is organized to set the HDD unit 40 to automatic erasure type in accordance with this display screen.

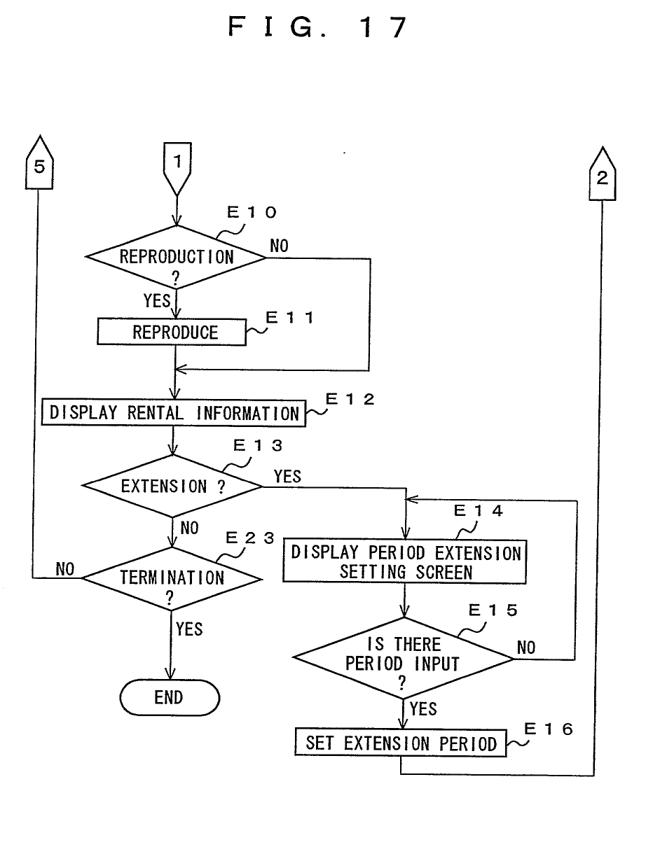

In addition after the HDD unit has been set to automatic erasure type, a menu key such as infrared-ray remote controller is operated, and an “external hard disk setting menu” shown in FIG. 15 is displayed so as to change its setting. At this time, the following message is displayed on the monitor screen.

This hard disk setting is changed.

If you do not set the disk to automatic erasure type, a rental video cannot be recorded in this disk.

Enter your desired number from:

1. Automatic erasure type

2. General type.”

The user is organized to change the setting of the HDD unit 40 to automatic erasure type or general type (copyright management mechanism).

Now, an example of processing in the home AV server 200 according to the present invention will be described here. In this example, the home AV server 200 has functions for reproducing rental video data, receiving and reproducing a TV broadcast, a reproducing recorded video, reproducing shopping data, reproducing a video image during Internet access, and reproducing a video image during video reservation or the like. Now, an example of processing during selection of a recorded video and an example of processing during selection of a rental video, will be described here.

With respect to this recorded video, a description will be given by exemplifying a case of selecting a “Star Wars” (famous cinema video) with no age limitation. With respect to a rental video, a description will be given by exemplifying a case of selecting an adult video with its predetermined age limitation. Of course, an HDD unit 40 with its time limit storage function that can be automatically erased is attached to the home AV server 200. Presume that this home AV server 200 and a video lease management apparatus 16 of a rental video service provider are connected to each other by communication means 2 such as Internet.

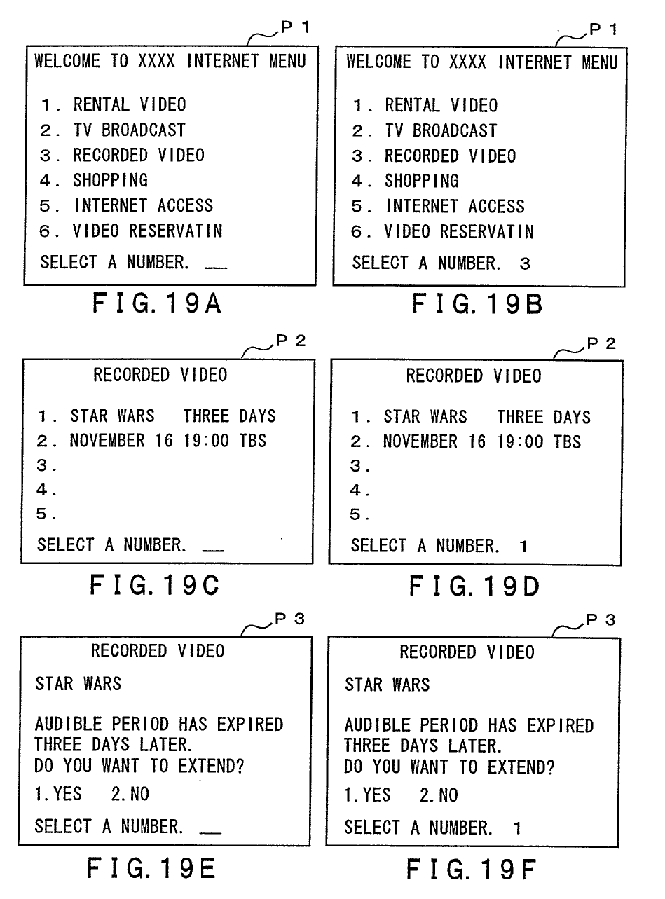

With this being presumed, a startup screen P1 as shown in FIG. 19A is displayed on a monitor 8 at the step E1 in the flow chart shown in FIG. 16. A welcome Internet is displayed on this startup screen (menu screen) P1, and the six menu items, i.e., 1. rental video, 2. TV broadcast, 3. Recorded video 4. Shopping, 5. Internet, 6 Video reservation or the like are displayed with content number. At the lower part of the menu, a message “Select a number” is displayed. Then, processing goes to the step E2 at which the user select any one of these six menu items.

### EXAMPLE OF PROCESSING DURING SELECTION OF RECORDED VIDEO

In this example, when a number 3 is input in order to select a recorded video shown in FIG. 19B at the step E2, a recorded video listing screen P2 shown in FIG. 19C is displayed on a monitor 8 at the step E3. On this recorded video listing screen P2, “1. Star Wars 3 days, 2. November 16, 19:00 TBS” is displayed, the number 3 to 5 are displayed as being blanked, and at the lower part, a display “Select a Number” is displayed. “Star Wars” in the display contents denotes a program title. This “Star Wars” presumes recording of the TV broadcast program. Thus, “November 16, 19:00” is displayed as recording date and time, and “TBS” is displayed as broadcast station name. “3 days” denotes the remaining audible period, and at “0 day”, recorded video data is automatically erased. The remaining audible period is computed from a time when downloading has been completed, and its erasure timing is a time that corresponds to the completion of downloading at “0-th day”.

Then, processing goes to the step E4 at which the home AV server 200 waits until content number has been selected in this recorded video listing screen P2. After any one of the content numbers has been selected, if a number “1” is input in order to select “1 Star Wars” shown in FIG. 19D in this example, processing goes to step ES at which the monitor screen is changed from the recorded video listing screen P2 to the lease period setting screen P3 shown in FIG. 19E.

On this lease period setting screen P3, a message “Audible period will expire three day later. Do you want to extend the period? 1. Yes 2. No” is displayed, and a message “Select a Number” is displayed at the lower part. Then, processing goes to the step E6 at which the home AV server 200 waits until a content number has been selected in this lease period setting screen P3. When any one of the content numbers is selected, a number “2” is input to select “2. No” shown in FIG. 19F in this example.

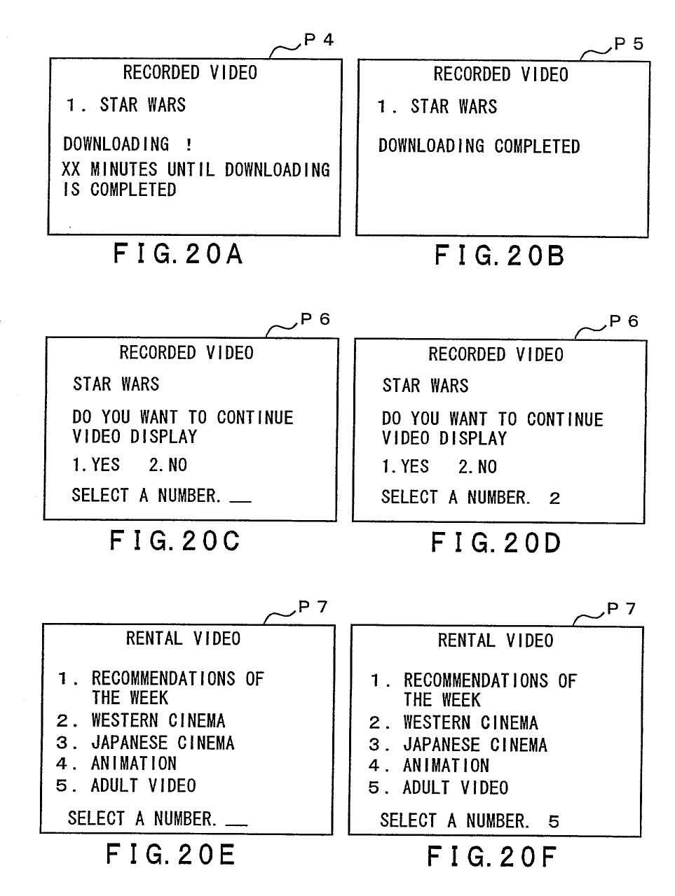

Although a lease charge is not shown, when all the utilization conditions are set, processing goes to the step E7 at which recorded video data having added thereto the utilization condition information concerning rental video lease is downloaded on the HDD unit 40. During the downloading period, the download display screen P4 shown in FIG. 20A is displayed. When this downloading completes, processing goes to the step E8 at which a downloading completion screen P5 shown in FIG. 20B is displayed on the monitor 8. Then, processing goes to the step E9 at which the display is changed from the downloading completion screen P5 to a reproduction check screen P6 shown in FIG. 20C.

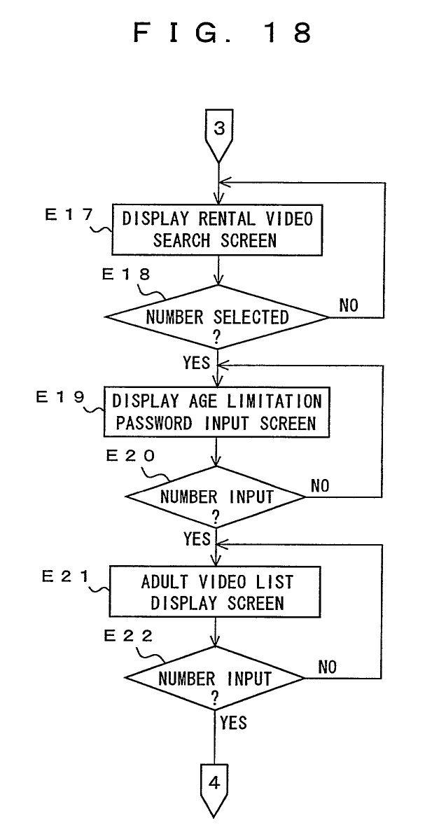

On this reproduction check screen P6, in addition to a display “Star Wars”, a message “Do you want to continue seeing video? 1. Yes 2. No” is displayed, and a message “Select a Number” is displayed at the lower part. Then, processing goes to the step E10 in the flow chart shown in FIG. 17 at which it is checked whether or not recorded video data is reproduced.

Here, in the case where a number “1” is input on the reproduction check screen P6 and reproduce the video, processing goes to the step E11 and recorded video data is reproduced. In the case where a number 2 is input on the reproduction check screen P6, thereby disabling video reproduction, processing goes to the step E12. At the step E12, a rental video search screen P7 shown in FIG. 20E is displayed on the monitor 8. On this rental video search screen P7, in addition to a display “Rental Video”, a menu display “1. Recommendation of the week 2. Western Cinema 3. Japanese Cinema 4. Animation 5. AV (Adult Video)” is displayed. A message “Select a Number” is displayed at the lower part.

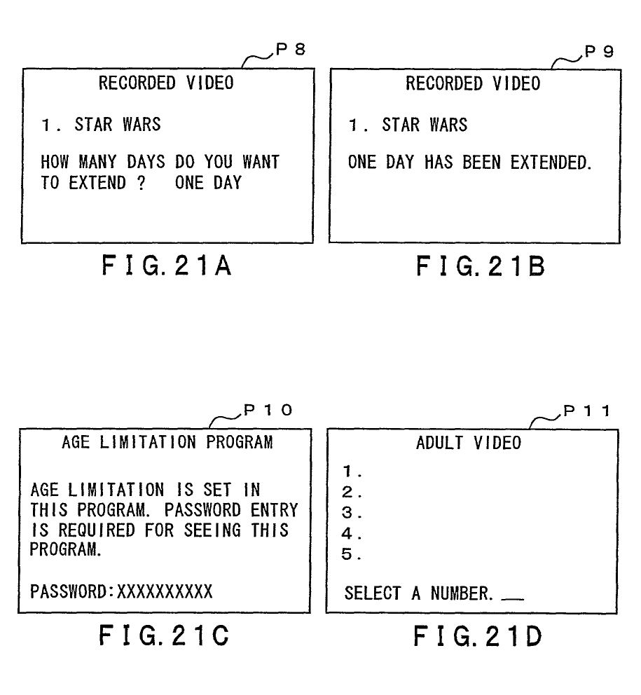

When a number 5 shown in FIG. 20F is input on this display screen, an adult video can be selected. This selection will be described in an example of processing during rental video selection. In this example, processing goes to the step E13 at which it is checked whether or not the lease period of rental video data is extended. In the case of extending a lease period of rental video data, processing goes to the step E14 at which the display is changed from the rental video search screen P7 to the lease period extension setting screen P8 shown in FIG. 21A. On the lease period extension setting screen P8, in addition to the display “Star Wars” according to the information contents, a message “How many days do you want to extend? One day” is displayed.

Then, processing goes to the step E15 at which the home AV server 200 waits until the number of extension days is input in this lease period extension setting screen P8. With respect to the number of extension days, for example, if a number 1 is input, an extension check screen as shown in FIG. 21B is displayed. When the extension utilization conditions are established, processing goes to the step E16 at which the recorded video data extension period is set to a database of the video lease management apparatus 16, and is set to the CPU 53 in the HDD unit 40. Then, processing reverts to the step E9 at which the display is changed from the lease period extension setting screen P8 to the reproduction check screen P6. During this lease period, recorded video data can be reproduced any times at the step E11 in the flow chart shown in FIG. 17.

In this example, when a rental video is selected at the step E2 in the flow chart shown in FIG. 16, processing goes to the step E17 in the flow chart shown in FIG. 18 at which the rental video search screen P7 as shown in FIG. 20E is displayed on the monitor 8. Then, processing goes to the step E18 at which the home AV server 200 waits until a content number has been selected in this rental video search screen P7.

In this example, when a number “5” is input on the rental video search screen P7 shown in FIG. 20F in order to select “5. Adult Video”, processing goes to the step E19 at which the display is changed from the rental video search screen P7 to an age limitation program screen P10 shown in FIG. 21C. On the age limitation program screen P10, a message “age limitation is set to this program. Password entry is required to seeing this program” is displayed (audience limitation mechanism).

Processing goes to the step E20 at which the home AV server 200 waits until a “password XXXXXXXX” has input in this age imitation program screen P10. When the password “XXXXXXXX” is input, and the utilization conditions concerning age limitation are cleared, processing goes to the step E21 at which the monitor screen is changed from the age limitation program screen P10 to the adult video listening screen P11. The contents of the adult video listening screen P11 are eliminated.

Then, processing goes to the step E22 at which the home AV server 200 waits until a content number has been selected in the adult video listing screen P11. When any one of the content numbers is selected, processing goes to the step E5 at which the monitor screen is changed from the adult video listing screen P11 to the lease period setting screen P3. On this lease period setting screen P3, a message “The audible period has expired three days later. Do you want to extend the period? 1. Yes 2. No” is displayed, and a message “Select a Number” is displayed at the lower part.

Then, processing goes to the step E6 at which the home AV server 200 waits until a content number has been selected in this lease period setting screen P3. Then, any of the content numbers is selected. Although a lease charge is not shown, when all the utilization conditions are set, processing goes to the step E7 at which adult video data having added thereto the utilization condition information concerning a rental video lease is downloaded from the video lease management apparatus 16 to the HDD unit 40. When downloading has completed, processing goes to the step E8 at which the downloading completion screen P5 as shown in FIG. 20A is displayed on the monitor 8 although the display contents are different from each other. Then, processing goes to the step E9 at which the display is changed to the reproduction check screen P6 although the display contents are different from each other.

Then, processing goes to the step E10 in the flow chart shown in FIG. 17 at which it is checked whether or not adult video data is reproduced. In this way, during the lease period, adult video data can be reproduced any time in the same manner as recorded video data. In the case where video reproduction is not performed, processing goes to the step E12. Further, in the case where the lease period of rental video data is not extended at the step E12, processing goes to the step E23. At the step E23, it is checked whether or not reception and reproduction processing is terminated by the home AV server 200. In the case where reception and reproduction processing is continued, processing goes to the step E1. In the case where reception and reproduction processing is terminated, power supply OFF information is detected, and the processing is terminated.

In this way, according to the home AV server 200 according to the second embodiment of the present invention, when rental video data having added thereto utilization condition information concerning rental video lease is received by a network interface 25, this rental video data is downloaded on the HDD unit 40, and is stored. Then, in the home AV server 200, when the lease period has expired based on the utilization condition information, the rental video data can be automatically erased from among the HDD units 40 (time shift function).

Therefore, there can be provided a business model using Internet or communication lines such as telephone lines or satellite communication lines, the rental video distribution business model having its rigid copyright management mechanism in which an illegal copy is difficult. In this manner, a copyright owner can be protected by a strict and rigid copyright protecting function for famous cinemas.

Although this example describes a case of a rental video distribution business model, the present invention is not limited to this case. When an information lease management method according to the present invention is applied, there can be constructed a rental electronic library system or a home-use communication karaoke system and the like.

Industrial Applicability

As has been described above, the present invention is very preferably applied to a rental video system, a rental electronic library system, or home-use communication karaoke system and the like using Internet or communication lines such as telephone lines or satellite communication lines.

1. A system for managing lease of arbitrary information contents to be distributed from an information lease service provider to a user, the system comprising:
an information lease management apparatus for adding utilization condition information concerning lease of information contents to information contents, and processing the information so as to be distributed to the user;
an information processing apparatus for receiving information contents with utilization condition information distributed from the information lease management apparatus; and
communication means for connecting the information lease management apparatus and information processing apparatus, characterized in that the information processing apparatus is managed so as to automatically erasing the received information contents by using communication means based on the utilization condition information.

2. An information lease management system as claimed in claim 1, characterized in that an automatically erasable recording medium with its time limit storage function, the recording medium storing said information contents, is connected to said information processing apparatus, and when a lease period has expired, the rented information contents are automatically erased based on utilization condition information.

3. An information lease management system as claimed in claim 1, characterized in that said recording medium has a data erasure mechanism for automatically erasing said information contents when the recording medium is removed from said information processing apparatus.

4. An information lease management system as claimed in claim 1, characterized in that a contract concerning lease of said information contents is made between said information lease service provider and a user.

5. An information lease management system as claimed in claim 1, characterized in that Internet, telephone lines, satellite communication line or lease communication lines are used as said communication means.

6. An apparatus for managing lease of information contents distributed from an information lease service provider to a user, the apparatus characterized by comprising:
data processing means for adding utilization condition information concerning information lease to a user to information contents; and
transmission and reception means for distributing to a user the information contents having the utilization condition information added thereto by the data processing means or receiving response information from the user.

7. An information lease management apparatus as claimed in claim 6, characterized in that there is provided a database storing information contents to be leased to said user.

8. An information lease management apparatus as claimed in claim 6, characterized in that at least menu screen information describing a title of information contents stored in said database is provided to a user.

9. An information lease management apparatus as claimed in claim 6, characterized in that at least a title of said information contents, lease charge and lease period, and a list of said users are integrally managed.

10. An information lease management apparatus as claimed in claim 6, characterized in that, in the case where an upper limit of an amount of money predetermined in accordance with a contract is provided, said data processing means obtains a cumulative utilization charge in which lease charges of said information contents are cumulated;
compares said upper limit of an amount of money and said cumulative utilization charge with each other; and
present lease rejection of said information contents or a change of said upper limit of an amount of money in the case where said cumulative utilization charge exceeds said upper limit of amount of money.

11. An apparatus for receiving information contents leased from an information lease service provider to a user, said apparatus characterized by comprising:
transmission and reception means for receiving information contents having added thereto utilization condition information concerning information lease to the user;
data processing means for processing information contents received by the transmission and reception means; and
a recording medium connectable to the data processing means in order to store information contents, wherein the data processing means is provided so as to automatically erase information contents stored in a recording medium based on the utilization condition information.

12. An information processing apparatus as claimed in claim 11, characterized in that said recording medium comprises a data erasure mechanism for, when the recording medium is removed from said data processing means, automatically erasing information contents stored in said storage means.

13. An information processing apparatus as claimed in claim 11, characterized in that said data erasure mechanism comprises:
detection means for detecting the fact that the recording medium is removed from said data processing means; and
control means for controlling disconnection of power supply to storage means based on removal detection information caused by said detection means.

14. An information processing apparatus as claimed in claim 11, characterized in that, when power supply to said recording medium is disconnected, there is provided a lock mechanism for fixing the recording means to said data processing means.

15. An information processing apparatus as claimed in claim 11, characterized in that there is provided display means for displaying index information concerning said information contents.

16. An information processing apparatus as claimed in claim 15, characterized in that at least a menu screen describing a title of said information contents is displayed on said display means.

17. An information processing apparatus as claimed in claim 16, characterized in that arbitrary information contents selected from said menu screen are distributed to said storage medium.

18. An information processing apparatus as claimed in claim 11, characterized in that there is provided operation means operated so as to input setting information concerning lease of said information contents.

19. An information processing apparatus as claimed in claim 11, characterized in that an upper limit of an amount of utilization charge of the information contents is set with respect to lease of said information contents.

20. An information processing apparatus as claimed in claim 11, characterized in that said utilization condition information contains a control program for selecting whether or not a lease period of said information contents is extended.

21. An information processing apparatus as claimed in claim 11, characterized in that, in the case where age limitation is set with respect to lease of said information contents, said utilization condition information contains a control program for inputting a predetermined user registered password number.

22. An information processing apparatus as claimed in claim 11, characterized in that, in the case where a lease period of said information contents is arbitrarily set, said utilization condition information contains a control program for inputting a lease period of said information contents.

23. A method of managing lease of information contents distributed from an information lease service provider to a user by using communication means, said method is characterized by comprising the steps of:
making a contract concerning lease of information contents in advance between the information lease service provider and the user;
adding utilization condition information to information contents to be distributed to the user based on the contrast on one hand, receiving information contents having utilization condition information added thereto on the other hand; and
storing the received information contents in a recording medium with its automatically erasable time limit storage function; and
automatically erasing the information contents stored in the recording medium based on the utilization condition information.

24. An information lease management method as claimed in claim 23, characterized in that Internet or communication lines such as telephone line or satellite communication lines are used.

25. An information lease management method as claimed in claim 23, characterized in that, in the case where said recording medium is attached to a data processing unit, when said storage medium is removed from said data processing unit, information contents contained in said recording medium is automatically erased.

26. An information lease management method as claimed in claim 23, characterized in that a user is presented with index information concerning a plurality of information contents to be leased to said user.

27. An information lease management method as claimed in claim 26, characterized in that at least a menu screen describing a title of said information contents is displayed.

28. An information lease management method as claimed in claim 27, characterized in that arbitrary information contents selected from said menu screen is distributed.

29. An information lease management method as claimed in claim 23, characterized in that a lease period of said information contents are arbitrarily input with respect to a lease contract of said information contents.

30. An information lease management method as claimed in claim 23, characterized in that an upper limit of an amount of money for utilization charge of said information contents is set with respect to a lease contract of said information contents.

31. An information lease management method as claimed in claim 30, characterized by comprising the steps of:
in the case where an upper limit of an amount of money is set with respect to a lease of said information contents, obtaining a cumulative utilization charge in which at least lease charges of said information contents are cumulated;
comparing said upper limit of an amount of money with said cumulative utilization charge; and
in the case where said cumulative utilization charge exceeds said upper limit of an amount of money, presenting lease rejection of said information contents or a change of said upper limit of an amount of money.

32. An information lease management method as claimed in claim 23, characterized in that, in the case where age limitation is set with respect to lease of said information contents, a predetermined, user registered password number is input.

33. An information lease management method as claimed in claim 23, characterized in that, when a lease period of said information contents has expired, it is selected whether or not the lease period of said information contents is extended.

34. An information lease management method as claimed in claim 23, characterized in that at least a title of said information contents, lease charge and lease period, and a list of said users are integrally managed.

35. A recording medium for recording information contents with utilization condition information leased from an information lease service provider to a user, characterized in that, when a predetermined lease period has expired, information contents stored in the recording medium is automatically erased based on said utilization condition information.

36. A recording medium as claimed in claim 35, characterized in that, in the case where said recording medium is attached to data processing means, when the recording medium is removed from said data processing means, there is provided a data erasure mechanism for automatically erasing information contents stored in the recording medium.

37. A recording medium as claimed in claim 35, characterized in that, said data erasure mechanism comprises:
detection means for detecting the fact that the recording medium is removed from said data processing means; and
control means for controlling disconnection of power supply to storage means based on removal detection information caused by said detection means.

38. A recording medium as claimed in claim 35, characterized in that, when power supply to the recording medium is disconnected, there is provided a lock mechanism for fixing the recording medium to said data processing means.
